(19) United States
(12) Patent Application Publication
(10) Pub. No.: US 2013/0319931 A1
(43) Pub. Date: Dec. 5, 2013

(54) METHOD OF FORMING AND IMMOBILIZING METAL NANOPARTICLES ON SUBSTRATES AND THE USE THEREOF

(71) Applicants: Hongjun Liu, Singapore (SG); Ziyu Jin, Singapore (SG); Yining Liu, Singapore (SG)

(72) Inventors: Hongjun Liu, Singapore (SG); Ziyu Jin, Singapore (SG); Yining Liu, Singapore (SG)

(73) Assignee: AGPLUS TECHNOLOGIES PTE. LTD., Singapore (SG)

(21) Appl. No.: 13/487,852

(22) Filed: Jun. 4, 2012

(51) Int. Cl. D06M 11/83; C02F 1/50; C08B 15/06

(52) U.S. Cl. CPC D06M 11/83; C08B 15/06; C02F 1/50
USPC 210/488; 536/30; 8/116.1

(57) ABSTRACT

A new, facile, low cost and easy-to-operate method of forming and immobilizing metal nanoparticles on substrates is invented. The method comprises steps of chemical modification of the substrates with chemical linkers, chelation of the metal ions to the modified substrates, the washing of the unbound metal ions and in-situ reduction of the metal ions to produce metal nanoparticles on the substrates with/without the finishing treatment of the metal nanoparticles functionalized substrates with minimum particles aggregations. The metal nanoparticles functionalized substrates generated by the method have wide applications, for example, as anti-microbial agents. The metal nanoparticles are strongly bonded to the substrates, resulting in low metal leaching to the environment.

### FIELD

The invention relates to methods of forming and immobilizing metal nanoparticles on substrates and the uses of such substrates having immobilized metal nanoparticles thereon.

### BACKGROUND

Metal nanoparticles as antimicrobial agents, catalyst, high-value colorants, photocatalyst, sensors and electromagnetic shielding technologies have gained significant research attention both on the synthesis of the materials as well as the applications of the resulting materials.

For instance, nanosilver is one of the most active antimicrobial nanostructures currently known and is a rapidly emerging technology. Nanosilver containing materials that provide added antimicrobial, antifungal and antiviral protection have already found their way into various products in the global market place, which was valued at ˜$45 billion in 2010.

Currently, many procedures and processes for the synthesis of silver nanoparticles have been developed whereby the end product is either a colloidal dispersion or a stabilized nanoparticle paste or solid that can then be dissolved or dispersed in a solvent. Although the simple preparation of nanoparticles has come a long way, the integration of the functional nanosilver directly into products for defined applications still remains a challenge. A method of attaching nanoparticles to substrates has been reported. When the as-prepared nanoparticles have linking (reactive) groups on their surfaces, they can be attached to a substrate (textile, plastic, fiber, etc.) using appropriate linking chemistry between the reactive nanoparticles and the substrate. In the reported method, they must first be synthesized, functionalized nanoparticles before the attachment process, typically using harmful organic solvents. The nanoparticles are then attached to the reactive substrate in a subsequent process step. This complicated multi-step processing is impractical for expedient and low cost manufacturing of nanoparticles on inexpensive commodity-based substrates like a fiber or a fabric like cotton, rayon and other textile like materials. Furthermore, the storage and transportation of the as-synthesized nanosilver particles or suspensions holds potential risk to the environment. The dispersion techniques for silver nanoparticles have always been a challenge in avoiding particle aggregations, which may cause textiles to have non-uniform nanosilver mapping and uneven antimicrobial properties.

Thus, the in situ preparation of metal nanoparticles on substrate is favored as an emerging concept in nanotechnologies. One method for the deposition of silver nanoparticles on the surface of substrates is by selecting from natural or synthetic textile fibers in an in situ preparation process, in which the formation of the nanoparticles and their adhesion to the fibers' surface occur at the same time. However, about 10% of the silver was leached to the environment with one time washing; and 74% of the silver was lost from the textile after ten times washing. The major drawback is the weak adhesion of the metal nanoparticles to the substrates which results from the weak bonding of hydroxy groups on the substrates to the metal nanoparticles. This will compromise and limit the potential applications of the nanosilver substrates. Particularly, it would not be practical to use such treated substrates as antimicrobial medical dressings for fear of leaching and the fear of potential unknown properties this may have on patients. Furthermore, the high silver leaching will cause environmental risk, since there are also concerns in the use of nanosilver related products due to uncertain environmental implications (EPA 2010. Scientific, Technical, Research, Engineering and Modeling Support Final Report. State of the science literature review: Everything nanosilver and more).

Any application of immobilized metal nanoparticles on a substrate that comes into contact with a fluid such as a liquid will always be at risk of leaching of the metal into the environment. When the environment is blood, tissue, or drinking water that comes into direct contact with a human or animal body the risk or fear due to uncertain environmental implications is multiplied.

### SUMMARY

Accordingly, a first aspect of the invention provides a method of immobilizing a metal nanoparticle on a substrate comprising the steps of (a) Modifying the substrate with a linker having a first linker element able to form a covalent bond with an element on the substrate that has a comparable electronegativity with the first linker element; and a second linker element able to chelate a metal ion; and (b) Washing the modified substrate to remove silver ions not chelated to the second linker element prior to reducing the metal ions to form the metal nanoparticles on the substrates with a reducing agent resulting in a treated substrate.

Preferably, the method further comprises the step of isolating the treated substrate stabilized metal nanoparticles.

Preferably, the method further comprises the step of washing the treated substrate with the linker.

Preferably, the substrate is a powder, a fiber, a fabric, a sheet or a film comprising at least one of cellulose, cotton, cellophane, rayon, nylon, polyvinyl alcohol, hydroxylated polystyrene, wood, paper, cardboard, linen, polymer element or a mixture thereof.

Preferably, the linker is prepared in a single step or in a multiple step process. Wherein the linker prepared in the single step is selected from the group, (3-mercaptopropyl)trimethoxysilane, bis[3-(triethoxysilyl)propyl]tetrasulfide, (3-aminopropyl)triethoxysilane, (3-aminopropyl)trimethoxysilane, 3-aminopropylmethyldiethoxysilane, N-(2-aminoethyl)-3-aminopropyltrimethoxysilane, N-(2-aminoethyl)-3-aminopropylmethyldimethoxysilane, (3-trimethoxysilylpropyl)diethylene-triamine, n-butylaminopropyltrimethoxysilane, N-ethylaminoisobutyltrimethoxysilane, N-methylaminopropyltrimethoxysilane, N-phyenylaminopropyltrimethoxysilane, bis(triethoxysilylpropyl)amine, bis(trimethoxysilylpropyl)amine, bis[3-trimethoxysilyl)propyl]ethylenediamine, N-(3-triethoxysilylpropyl)-4,5-dihydroimidazole, ureidopropyltriethoxysilane, 3-isocyanatopropyltriethoxysilane; isocyanate: toluene diisocyanate, and hexamethylene diisocyanate. Wherein the linker prepared in a multiple step process has a structure of A-Nₙ-B wherein the first linker element (Linker A) is an epoxy group; the first linker element is attached on the substrate, followed by electrophilic addition to a central Linker element N, which can react with the second linker element (Linker B).

Preferably, the linker prepared in a multiple step process has the first linker element, Linker A selected from the group, 2-(chloromethyl)oxirane, 2-(bromomethyl)oxirane, 2-(iodomethyl)oxirane, 1,4-butanediol diglycidyl ether and a mixture thereof.

Preferably, the linker prepared in a multiple step process has the central linker element, linker N having a formula of Q-R′—P, in which Q represents a functional group which contains a nucleophilic moiety and P represents a functional group which contains an electrophilic moiety. R¹ represents a third linker between Q and P.

Preferably, the linker prepared in a multiple step process has the second linker element, linker B having a formula of Y—R²—Z, in which Y represents a functional group which contains a nucleophilic moiety, Z represents a functional group which contains a functional binding moiety, and R² represents a forth linker between Y and Z. Wherein the nucleophilic moiety Q comprises at least one of amine, thiol, alcohol, phenol, carboxylate, polymer or a mixture thereof. Wherein the nucleophilic moiety Y comprises at least one of amine, thiol, alcohol, phenol, carboxylate, polymer or a mixture thereof. Wherein the electrophilic moiety P comprises a least one of azide, cyanuric, isocyanate, silane or a mixture thereof. Wherein the binding moiety Z comprises a least one of amine, sulfonic acid, phosphonic acid, carboxylic acid, phosphonate, sulfonate, thiol, carboxylate, azide, cyanuric, isocyanate, alcohols, thiols, polymer or a mixture thereof. Wherein the functional group R¹ comprises at least one of alkyl, aryl, heteroaryl, vinyl, oligomer, polymer or a mixture thereof. Wherein the functional group R² comprises at least one of alkyl, aryl, heteroaryl, vinyl, oligomer, polymer or a mixture thereof.

Preferably, the metal is selected from the group silver, gold, platinum, palladium, aluminum, iron, zinc, copper, cobalt nickel, manganese, chromium, molybdenum, cadmium, iridium and a mixture thereof. Most preferably the metal is silver.

Preferably, the size of metal nanoparticle ranges from 1-2000 nm

Preferably, the reducing agent comprises sodium bromohydrate (NaBH₄), a reducing sugar, N-vinyl pyrrolidinone (NVP), polyvinyl pyrrolidinone (PVP), phenylhydrazine, hydrazine, citrate acid, ascorbic acid, amine, phenol, alcohol or a mixture thereof.

Preferably, isolating the treated substrate stabilized metal nanoparticles comprises filtering, washing, drying or a mixture thereof.

Preferably, the linker used in the step of washing the treated substrate is selected from the group, (3-mercaptopropyl)trimethoxysilane, bis[3-(triethoxysilyl)propyl]tetrasulfide, (3-aminopropyl)triethoxysilane, (3-aminopropyl)trimethoxysilane, 3-aminopropylmethyldiethoxysilane, N-(2-aminoethyl)-3-aminopropyltrimethoxysilane, N-(2-aminoethyl)-3-aminopropylmethyldimethoxysilane, (3-trimethoxysilylpropyl)diethylene-triamine, n-butylaminopropyltrimethoxysilane, N-ethylaminoisobutyltrimethoxysilane, N-methylaminopropyltrimethoxysilane, N-phyenylaminopropyltrimethoxysilane, bis(triethoxysilylpropyl)amine, bis(trimethoxysilylpropyl)amine, bis[(3-trimethoxysilyl)propyl]ethylenediamine, N-(3-triethoxysilylpropyl)-4,5-dihydroimidazole, ureidopropyltriethoxysilane, 3-isocyanatopropyltriethoxysilane; isocyanate: toluene diisocyanate, and hexamethylene diisocyanate.

Another aspect of the invention provides a treated substrate obtained by the method of the invention wherein less metal ion is leached to the environment.

Preferably, the treated substrate comprises a colour including red, yellow, blue, green, purple, gray or black

Preferably, the treated substrate comprises antimicrobial properties.

Preferably, the treated substrate is for use as a catalyst, water purification devices, absorbent, healthcare products, sensor, food packaging films or a mixture thereof.

Another aspect of the invention provides a device for water purification comprising the treated substrate of the invention wherein the metal nanoparticle is silver and the substrate is cotton textile suitable for emersion in water that needs purifying.

Another aspect of the invention provides a cartridge comprising the treated substrate of the invention for filtering water.

Preferably, the cartridge further comprises active carbon; and zirconium compounds. Preferably, the cartridge is for use in a filter drinking straw whereby water is able to enter through an inlet, pass through at least one cartridge and be suitable for drinking.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

The figures illustrate, by way of example only, embodiments of the present invention, are as described below.

FIG. 1. A schematic depiction of the method to make the metal nanoparticles on substrates.

FIG. 2A. Nanosilver cotton textile: a) untreated cotton; b) cotton without MTS surface treatment and silver nanoparticle formation; c) MTS treated cotton and silver nanoparticle formation; d) ATS post-treated nanosilver cotton textile.

FIG. 2B. Nanosilver cotton textile without the washing step during the synthesis.

FIG. 3. A schematic depiction of an embodiment showing the use of immobilizing metal nanoparticles on substrates as a water filter/purifier.

FIG. 4 A schematic depiction of an embodiment showing the use of immobilizing metal nanoparticles on substrates as a filter cartridge in a filter drinking straw.

### DETAIL DESCRIPTION

In general, the present invention introduces a low cost and efficient method of forming and immobilizing metal nanoparticles on substrates with minimal metal leaching to the environment.

The present invention introduces a method which comprises the steps of forming metal nanoparticles on substrates via the chemical modification of the substrates with functional groups which have strong binding affinities to metal ions as well as the generated nanoparticles, chelation of the metal ions and in-situ reduction of the metal ions to metal nanoparticles. The combination of the strong binding between the substrate, linker and the metal nanoparticles and the disruption of any weak hydroxyl bonds between the substrate and the metal nanoparticles minimizes the metal leaching to the environment.

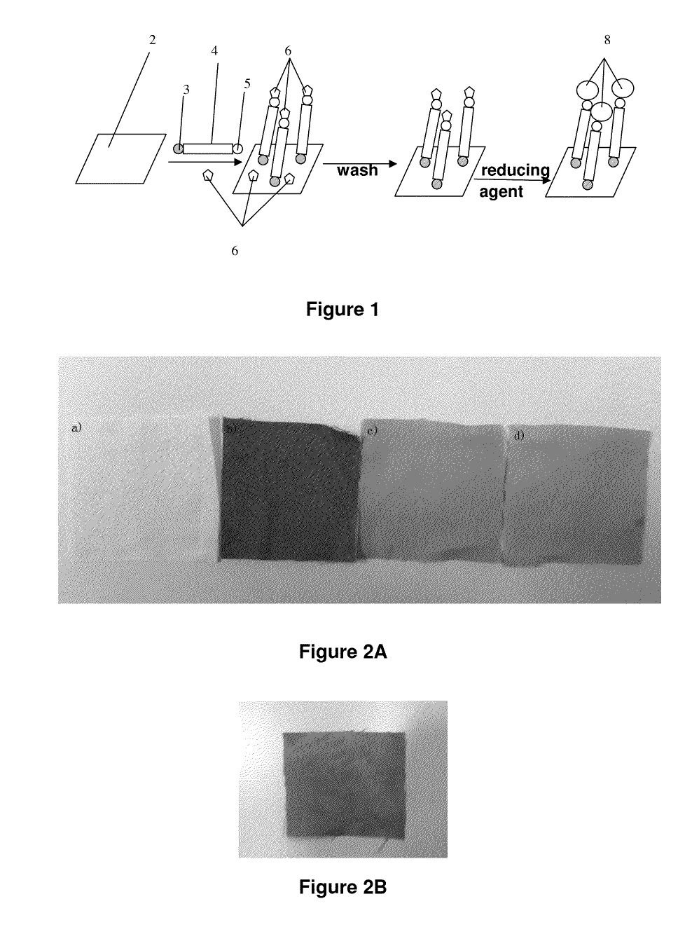

In reference to FIG. 1, the present invention introduces a method of forming and immobilizing metal nanoparticles on substrates 2.

The substrate 2 is in a form of powder, fiber, fabric, sheet or film, which is, in an embodiment preferably, comprised of at least one of cellulose, cotton, cellophane, rayon, nylon, polyvinyl alcohol, hydroxylated polystyrene, wood, paper, cardboard, linen, polymers and mixtures thereof. The substrate 2 has a chemical nature with at least one electrophilic group thereon, which is preferably alcohol, phenol, amine, thiol, ether, thioether, disulfide, sulfinyl, sulfonyl and carbonothioyl, for reacting with a first linker element 3.

In one preferred embodiment the substrate is cellulose particles. In another preferred embodiment the substrate is cellulose based fabric such as cotton.

The substrate 2 is first modified to prepare the substrate for the formation of strong bonds to immobilize a metal nanoparticle 8 on the substrate. Modification of the substrate is done with a linker 4, the linker can also be referred to as a coupling reagent or surface modifier.

The linker 4 can be attached in a single step using silanes, diisocyanate, isocyanate, isothiocyanate, carboxylic chloride, azide, nitroso and the like; preferably, (3-mercaptopropyl)trimethoxysilane, bis[3-(triethoxysilyl)propyl]tetrasulfide, (3-aminopropyl)trimethoxysilane, 3-aminopropylmethyldiethoxysilane, N-(2-aminoethyl)-3-aminopropyltrimethoxysilane, N-(2-aminoethyl)-3-aminopropylmethyldimethoxysilane, (3-trimethoxysilylpropyl)diethylene-triamine, n-butylaminopropyltrimethoxysilane, N-ethylaminoisobutyltrimethoxysilane, N-methylaminopropyltrimethoxysilane, N-phyenylaminopropyltrimethoxysilane, bis(triethoxysilylpropyl)amine, bis(trimethoxysilylpropyl)amine, bis[(3-trimethoxysilyl)propyl]ethylenediamine, N-(3-triethoxysilylpropyl)-4,5-dihydroimidazole, ureidopropyltriethoxysilane, 3-isocyanatopropyltriethoxysilane, (3-aminopropyl)triethoxysilane, hexamethylene diisocyanate, toluene diisocyanate, 2-(3-(prop-1-en-2-yl)phenyl)prop-2-yl isocyanate, methyl isocyanate, methyl isothiocyanate, 2-(3-(prop-1-en-2-yl)phenyl)prop-2-yl isocyanate, 2-phenylethylisocyanate, tosyl isocyanate, 2,2,4-trimethylhexamethylene-1,6-di-isocyanate, dicyclohexylmethane-4,4′-di-isocyanate, isophorone di-isocyanate, 1,5-naphthylene diisocyanate, methylenediphenyl diisocyanate. The linker 4 should have the characteristics of: a first linker element 3 that has the ability to form a covalent bond with an element on the substrate that has a comparable electronegativity with the first linker element 3; and a second linker element 5 comprising a chelant that is able to form a soluble, complex molecule with a metal ion 6, that is able to chelate a metal ion thereon.

The linker 4 can also be produced via multiple steps forming Linker A-Nₙ-B. For instance, a first linker element, (Linker A) with an epoxy group is first attached on the substrate, followed by electrophilic addition to another central linker(s), (Linker N). Linker N contains an electrophilic moiety which allows another second linker element, (Linker B) to react with and produce a functional group on the substrate. n is an integer and represents the number of Linker N, varying from 0 to 1000 in which Linker N can be identical or different in the variations.

The linker can be formed by multiple steps to form Linker A-Nₙ-B. In embodiments, a first linker (Linker A) comprises a nucleophilic moiety and an epoxy-containing moiety is used. In embodiments, the nucleophilic moiety in Linker A is selecting from halogen, epoxide, etc. Linker A reacts with the substrates via activation of a soluble base, selecting from sodium hydroxide, potassium hydroxide, cesium hydroxide, sodium carbonate, potassium carbonate, cesium carbonate, sodium bicarbonate, potassium bicarbonate, cesium bicarbonate, sodium acetate, potassium acetate, cesium acetate, etc. The base is dissolved in a solvent, selecting from water, alcohol, furan, pyridine, chloroform, methyl chloride, acetonitrile, toluene and the like.

In embodiments, another linker (Linker N) is used to react with the epoxy-containing moiety in the Linker A. Linker N has a formula of Q-R′—P, in which Q is a nucleophile to react with epoxy group in Linker A. Functional group P has an electrophilic moiety and R¹ represents a linker between Q and P. The nucleophile Q comprises at least one of amines, thiols, alcohols, phenols, carboxylate, or polymer. The electrophilic group P is selected from azide, cyanuric, isocyanate, silane and a mixture thereof. The linker R¹ comprises at least one of alkyl, aryl, heteroaryl, vinyl, oligomer, polymer and a mixture thereof. In embodiments, n represents the number of Linker N, ranging from 0 to 1000 in which Linker N can be identical or different in the variations.

In embodiments, another linker (Linker B) is used to react with the electrophilic moiety in the Linker N. Linker B has a formula of Y—R²—Z, in which Y represents the functional reacting moiety to the electrophilic moiety in the Linker N, Z represents the functional binding moiety to the formed metal nanoparticles and R² represents a linker between Y and Z. The binding moiety Y comprises at least one of amines, thiols, alcohols, phenols, carboxylate, or polymer. The binding moiety Z comprises a least one of the amines, sulfonic acid, phosphonic acid, carboxylic acid, phosphonate, sulfonate, thiol, carboxylate, azide, cyanuric, isocyanate, alcohols, thiols, polymer and a mixture thereof. The linker R comprises at least one of alkyl, aryl, heteroaryl, vinyl, oligomer, polymer and a mixture thereof.

The substrates should preferably contain functionalities for nucleophilic addition to Linker A and produce the epoxy group on the substrates. The functionalities can be hydroxy, phenoxy, amine, amide, aniline, thiol, carboxylic acid and the like. Linker N has a structure of Q-R′—P, in which functional group Q, selecting from hydroxy, phenoxy, amine, amide, aniline, thiol, acid and the like, is a nucleophile to react with the electrophilic moiety in Linker A; functional group P is an electrophilic moiety to react with Linker B; group R¹ is a hydrocarbon group to link functional group Q and P. Linker B has a structure of Y—R²—Z, in which functional group Y, selected from hydroxy, phenoxy, amine, amide, aniline, thiol, acid and the like, will react with the epoxy group on the substrate; functional group Z, selected from hydroxy, phenoxy, amine, amide, aniline, thiol, acid and the like, will act as the binding group to chelate the metal ions; group R² is a hydrocarbon group to link functional group Y and Z.

Again the linker 4 formed by multiple steps described above must have the characteristics of: a first linker element 3 that has the ability to form a covalent bond with an element on the substrate that has a comparable electronegativity with the first linker element 3; and a second linker element 5 comprising a chelant that is able to form a soluble, complex molecule with a metal ion 6.

Chelation of metal ions 6 occurs via the generated functional group of the linker 4 on the substrate. The metal 6 can be gold, silver, copper, palladium, platinum, iron, iridium, rhodium, etc. The metal ions 6 are derived from a soluble metal salt in solvent. The substrate modification step and metal ion chelating step can be achieved at the same time. This allows for cheaper and faster in situ preparation the substrate. In embodiments, the surface modification step and the metal ion chelating step can occur at the same time.

In embodiments, linker modified substrates can chelate the metal ions from a metal salt solution. The metal is selected, but not limited to, silver, gold, platinum, palladium, aluminum, iron, zinc, copper, cobalt nickel, manganese, chromium, molybdenum, cadmium, iridium and a mixture thereof. The metal salt is soluble in a solvent, selected from, water, alcohol, furan, pyridine, chloroform, methyl chloride, acetonitrile, toluene and the like.

A washing process is needed at this point to remove the unbound metal ions 6 and any metal ions 6 that have formed weak bonds directly with the substrate 2. This will have the effect of improving the overall quality of the metal nanoparticles on the substrates and will minimize any leaching of the metal ion to the environment from the final processed substrate. The washing solution can be selected from water, alcohol, hexane, toluene, dichlorobenzene, chlorobenzene, dichloromethane, chloroform, ethyl acetate, tetrahydrofuran, diethyl ether and or a mixture thereof. It is important that the washing step is done prior to the reduction of the metal ions 6 to form the metal nanoparticles 8 on the substrates 2. Once the metal nanoparticles have been formed it becomes more difficult to remove the metal ions 6 that have formed weak bonds directly with the substrate 2 as the reducing agent somewhat enhances such bonding.

In embodiments, the washing step is required to remove the unbound metal ions to the substrates. The washing step is essential to improve the quality of the final metal nanoparticles on substrates. The washing solution can be selected from water, alcohol, hexane, toluene, dichlorobenzene, chlorobenzene, dichloromethane, chloroform, ethyl acetate, tetrahydrofuran, diethyl ether and a mixture thereof.

In situ reduction of the metal ions 6 to form the metal nanoparticles 8 on the substrate 2 is achieved using a reducing agent. The reducing agent may be selected from sodium bromohydrate (NaBH₄), a reducing sugar, N-vinyl pyrrolidinone (NVP), polyvinyl pyrrolidinone (PVP), phenylhydrazine, hydrazine monohydrate, citrate acid, ascorbic acid, amine, phenol, alcohol and or a mixture thereof. Alternatively, any reducing agent known in the art to form metal nanoparticles from metal ions would be suitable. The in situ preparation can minimize the steps of nanoparticle preparation and reduce the cost of preparation.

In embodiments, the chelated metal ions are in situ reduced into metal nanoparticles by reducing agents. The metal nanoparticles are bonded to the substrates. The solvent is preferably water or a water mixture. The reducing agent is selected from sodium bromohydrate (NaBH₄), a reducing sugar, N-vinyl pyrrolidinone (NVP), polyvinyl pyrrolidinone (PVP), phenylhydrazine, hydrazine, citrate acid, ascorbic acid, amine, phenol, alcohol and a mixture thereof, preferably, sodium bromohydrate (NaBH₄) or a reducing sugar.

Further removal and Isolation of the metal nanoparticles stabilized by the substrates with minimum aggregations may be done to further reduce leaching of the metal ions from the substrate. The isolation step is used for purifying the final metal nanoparticles which is involved in separation, washing and drying process.

A post-treatment step to the treated substrate might also be beneficial to further minimize the leaching of metal to the environment. In the post treatment step the treated substrate is further washed in the linker/coupling reagent as described above. The linker will further bind any un-reacted metal ions to further minimize the leaching of metal to the environment by acting like a scavenger.

The treated substrate with metal nanoparticles have wide applications on healthcare products, sensor, anti-microbial agents, catalysts, water purification, chemical absorbent etc, in particular anti-microbial applications of substrates treated with silver nanoparticles.

The substrates supported silver nanoparticles prepared in all the embodiments have antimicrobial effects against bacteria, fungi, and/or chlamydia, which include, but are not limited to, Staphylococcus aureus, Klebsiella pneumonia, Escherichia coli, Chlamydia trachomatis, Providencia stuartii, Pneumobacillus, Vibrio vulnificus, Candida albicans, Bacillus cloacae, Pseudomonas maltophila, Pseudomonas aeruginosa, Streptococcus hemolyticus B, Citrobacter and Salmonella paratyphi C.

In embodiments, the metal nanoparticles modified substrates are isolated from a reaction mixture by a series of steps, including filtration, washing and drying. The washing process is required to remove the unreacted agents and unbound metal nanoparticles. The washing solution is preferably, but not limit to, in embodiments, to water based solutions.

The drying technique for the nanosilver textile is, in embodiments, are preferably selected from, but not limit to sources such as air, sunlight, oven, pump, nitrogen, infrared light and/or a mixture thereof.

The metal nanoparticles treated substrates, in embodiments, might show a range of colors including red, yellow, blue, green, purple, gray and black.

The metal nanoparticles treated substrates, in embodiments, show good to excellent antimicrobial properties, which include, but are not limited to, Staphylococcus aureus, Klebsiella pneumonia, Escherichia coli, Chlamydia trachomatis, Providencia stuartii, Pneumobacillus, Vibrio vulnificus, Candida albicans, Bacillus cloacae, Pseudomonas maltophila, Pseudomonas aeruginosa, Streptococcus hemolyticus B, Citrobacter and Salmonella paratyphi C.

The metal nanoparticles treated substrates can be used for catalyst, water purification devices, absorbent, healthcare products, sensor, food packaging films and a mixture thereof.

The method has advantages of minimizing the aggregation of the metal nanoparticles. The method is fast and provides easy, cost effective, preparation. The strong binding affinities of the metal nanoparticles to the substrates via a linker and the removal of any weak bonds provides low metal leaching to the environment. Less than 8% of the metal ion is leached to the environment after washing the treated substrate 50 times. 15% to 30% less metal ion is leached from the treated substrate prepared using the method of the invention compared to a substrate prepared without a washing step prior to reducing the metal ions to form the metal nanoparticles on the substrates with a reducing agent. The treated substrate prepared using the method of the invention demonstrated 4 to 21 times less silver leaching compared to a substrate prepared without a washing step prior to reducing the metal ions to form the metal nanoparticles on the substrates with a reducing agent. The treated substrate prepared using the method of the invention demonstrated 4 to 6 times less silver leaching compared to a substrate prepared without a washing step prior to reducing the metal ions to form the metal nanoparticles on the substrates with a reducing agent. The treated substrate prepared using the method of the invention demonstrated 10 to 21 times less silver leaching compared to a substrate prepared without a washing step prior to reducing the metal ions to form the metal nanoparticles on the substrates with a reducing agent and an extra wash with the linker.

In particular, the method to form metal nanoparticles on substrates includes the chemical modification of the substrates with chemical linkers, chelation of metal ions to the modified substrates, the washing of the unbound metal ions and in-situ reduction of the metal ions to metal nanoparticles with/without the finishing treatment of the metal nanoparticles functionalized substrates. The present invention also relates to applications of the prepared substrates with metal nanoparticles.

The present methods and uses are further exemplified by way of the following non-limited examples. Preferred embodiments are listed.

### EXAMPLES

### Example 1

### Preparation of Epoxy-Functionalized Cellulose

1 kg commercially available cellulose powder (Sigma-Aldrich) was suspended in 5 L of 1.5 M NaOH at 60° C. 1 L of epichlorohydrin was added to the suspension and stirred vigorously for 2 hours. The reaction mixture was filtered and the solid residue (“epoxy cellulose”) was washed with de-ionized water three times. The dry epoxy cellulose was obtained after pump drying.

### Example 2

### Preparation of Silver Nanoparticles on Cellulose

150 g of epoxy cellulose prepared in example 1 was suspended in 1 L of water. 200 mL 70% hexanemethylenediamine in water was added in one portion. The mixture is stirred for 2 hours and filtered by suction. The solid residue (“amino cellulose”) was washed with de-ionized water three times before.

The obtained wet amino cellulose was re-suspended in 1 L of silver nitrate aqueous solution (0.1M) and stirred for 3 hours. The reaction mixture was filtered and the solid residue was washed with de-ionized water three times before any reduction to form a metal nanoparticle was conducted. The solid residue was re-suspended in 1 L of water at room temperature. 100 mL of hydrazine aqueous solution (0.5M) was added into the reaction mixture in one portion and stirred at room temperature for 3 hours. The reaction mixture was filtered and the solid residue (“nanosilver amino-cellulose”) was washed with deionized water three times. After pump drying, the nanosilver amino-cellulose was obtained in 170 g. The size of the nanoparticles was 50-100 nm.

### Example 3

### Preparation of Silver Nanoparticles on Cellulose

150 g of epoxy cellulose prepared in example 1 was suspended in 1 L of sodium carbonate aqueous solution (2.0M). 100 g of iminodiacetic acid was added in one portion. The mixture is stirred for 12 hours at 60° C. and filtered by suction. The solid residue (“acidic cellulose”) was washed with de-ionized water three times.

The obtained wet acidic cellulose was re-suspended in 1 L of silver nitrate aqueous solution (0.1M) and stirred for 3 hours. The reaction mixture was filtered and the solid residue was washed with de-ionized water three times before any reduction to form a metal nanoparticle was conducted. The solid residue was re-suspended in 1 L of water at room temperature. 200 mL of Sodium borohydride aqueous solution (0.6M) was added into the reaction mixture in one portion and stirred at room temperature for 4 hours. The reaction mixture was filtered and the solid residue (“nanosilver acidic-cellulose”) was washed with de-ionized water three times. After pump drying, the nanosilver acidic-cellulose was obtained in 190 g. The size of the nanoparticles was 20-50 nm.

### Example 4

### Preparation of Nanosilver Cotton Textiles

A solution of (3-mercaptopropyl)trimethoxysilane (MTS) 5.0 mM and silver nitrate 2.5 mM in a liter of water was freshly prepared at 60° C. Broad cotton fabrics (3 g) were suspended in the MTS solution for 30 mins. The silver ions were bonded to the surface of the fabrics via the ionic bonding between the thiol group in the surface modifier at the second linker element and the silver ions. The unbound ones were wash off by ethanol before any reduction to form a metal nanoparticle was conducted. The silver bonded fabrics were subsequently soaked into a liter of an aqueous solution of sodium borate-hydride (NaBH₄) 1.0 mM, as the reducing agent, for 10 mins. A uniform yellow color was formed on the fibers gradually, which demonstrated formation of the silver nanoparticle on the fabrics. The nanosilver fabrics were removed from the reducing agent solution and washed with water to ensure the unbound silver nanoparticles are removed. The nanosilver fabrics were dried under 90° C. to give the final product, marked as P2 (FIG. 2, c). The size of the silver nanoparticles was about 20-50 nm.

A piece of nanosilver fabric P2 (3 g) were then subjected for a post-treatment in a liter of aqueous (3-aminopropyl)triethoxysilane (ATS) 2.0 mM solution at 60° C. for 20 mins. The sunlight drying of the fabrics resulted in P3 (FIG. 2, d). The size of the silver nanoparticles was about 20-50 nm, which is similar as that of P2.

As a control, broad cotton fabrics (3 g) were dipped into a liter of an aqueous solution of silver nitrate 2.5 mM for 10 mins at room temperature. The silver bonded fabrics were subsequently soaked into a liter of an aqueous solution of sodium borate-hydride (NaBH₄) 1.0 mM for 10 mins. A brown color was appearing on the fabrics, the fabrics were dried under 90° C. to give P1 (FIG. 2, b). The size of the silver nanoparticles was about 50-100 nm.

A solution of (3-mercaptopropyl)trimethoxysilane (MTS) 5.0 mM and silver nitrate 2.5 mM in a liter of water was freshly prepared at 60° C. Broad cotton fabrics (3 g) were suspended in the MTS solution for 30 mins. No washing step was performed on the treated fabrics. The silver bonded fabrics were subsequently soaked into a liter of an aqueous solution of sodium borate-hydride (NaBH₄) 1.0 mM, as the reducing agent, for 10 mins. A un-even color was formed on the fibers, which demonstrated that the formation of the silver nanoparticle on the fabrics is not uniform. The nanosilver fabrics were removed were dried under 90° C. to give the final product, marked as P4 (FIG. 2B). The size of the silver nanoparticles was about 20-100 nm.

### Example 5

### Determination of Antibacterial Properties the Nanosilver Cellulose Materials

The antimicrobial properties of the as-prepared nanosilver materials were evaluated by a modified version of AATCC Test Method 100-2004. The dried nanosilver cellulose materials (100 mg) was put into an aqueous bacterial suspension (10 mL) containing 10⁵-10⁶ colony-forming units (CFU)/mL of Staphylococcus aureus (ATCC 6538, Gram-positive) or Klebsiella pneumonia (ATCC 4352, Gram-negative). The mixture was shaken vigorously for 3 min and then the bacteria suspension was diluted to 100 mL in series with sterilized deionized water. A 100 uL aliquot of each dilution was placed on nutrient agar plates and then incubated at 37° C. for 24 h. Untreated cellulose materials were used as a base control sample. Bacterial reductions were calculated according to Eq. 1.

R=100(C−P)/C Eq. 1

R is % reduction, P is the number of bacteria recovered from the inoculated treated sample, and C is the number of bacteria recovered from the inoculated control sample.

The anti-microbial results for the tested nanosilver cellulose materials over the control samples were reported in Table 1.

TABLE 1
Antibacterial deduction of the nanosilver cellulose materials

| | | Count of test | | |
|---|---|---|---|---|
| | | microorganism | | |
| | | recovered from the | | |
| | | inoculated sample | | Percentage |
| Microorganisms | Sample | 0 | 24 h | Reduction |
| Staphylococcus | Control | 480 000 | 5 300 000 | — |
| aureus | nanosilver | — | 9 600 | 99.82% |
| (ATCC | amino-cellulose | | | |
| 6538) | nanosilver | — | 5 800 | 99.89% |
| | acidic-cellulose | | | |
| | P2 | — | 150 700 | 97.16% |
| | P3 | — | 900 | 99.98% |
| | P4 | — | 1 500 | 99.97% |
| Klebsiella | Control | 590 000 | 8 700 000 | — |
| pneumonia | nanosilver | — | 2 800 | 99.97% |
| (ATCC | amino-cellulose | | | |
| 4352) | nanosilver | — | 1 100 | 99.98% |
| | acidic-cellulose | | | |
| | P2 | — | 670 000 | 92.30% |
| | P3 | — | 6 700 | 99.92% |
| | P4 | — | 15 800 | 99.82% |

It is demonstrated in Table 1 that all 3 of the nanosilver fabrics reduced the amount of bacteria able to colonize on the agar. The nanosilver fabrics formed with MTS and washed with ethanol (P2), or ethanol and ATS (P3), resulted in a greater reduction in the amount of bacteria able to colonize on the agar.

### Example 6

### Washing and Silver Leaching Test of the Nanosilver Cotton Textiles

The washings were carried out according to a modification version of the AATCC standard “Standard for home laundering fabrics prior to flammability testing to differentiate between durable and non-durable finishes”, by using 0.6 mL of commercial detergent in 30 mL of water for each washing. The washings were performed at 37° C. with rotation speed of 75 rounds per minute. The commercial detergent contains: 5-15% by weight of anionic surfactants; less than 5% by weight of non-ionic surfactants; less than 0.5% phosphorous; and various additives. The nanosilver textile fabrics (P1, P2, P3 and P4), which were prepared from example 4, with a size of 10 cm by 3 cm (around 500 mg) each were washed separately in the washing solution for 1 hour, 10 hours and 50 hours; the washings for 10 and 50 hours simulated cycles of 10 and 50 washings respectively. After washing, each of the washing solutions was collected accordingly.

The washed solutions were subjected to measure the silver amount (ppb, μg silver per kg of water) by ICP-OES, evaluating the silver leaching from the nanosilver cotton textile and the results is summarized in Table 2.

TABLE 2
The silver washing and leaching test

| | |
|---|---|
| | Silver amount in |
| Number of | washing solution (ppb) |

| washings | P1 | P2 | P3 | P4 |
|---|---|---|---|---|
| 1 | 453 | 35 | 12 | 153 |
| 10 | 3,886 | 127 | 76 | 742 |
| 50 | 8,960 | 449 | 137 | 2875 |

As shown in Table 2, the silver leaching from the nanosilver textiles without surface treatment P1 is higher than the nanosilver textiles with surface treatment P2 and P3. The amount is significantly reduced by the surface treated nanosilver textiles P2. The finishing post-treatment of the nanosilver textiles (P3) further reduced the silver leaching from the textile. The non-washing nanosilver textile (P4) has a middle level of silver leaching from the textile, which demonstrated the importance of the washing steps. The washing step used in preparing P2 and P3 was able to reduce silver leaching to less than 8% of the silver leached from the crude preparation of P1. Further, while P4 was still able to reduce silver leaching to less than 19 to 34% of the silver leached from the crude preparation of P1, the silver leached from P4 was still about 15 to 30% more than the silver leached from P2 and P3 treated substrate. This was a reduction of leaching of ion of 4 to 6 and 10 to 21 times between P4 and P2 and between P4 and P2 respectively

Such nanosilver textiles made by the methods described herein have the advantage of being able to be used for various functions known to those skilled in the art with minimal silver leaching to the environment.

### Example 7

### Nanosilver Cotton Textile as Tool Kit for Water Purification

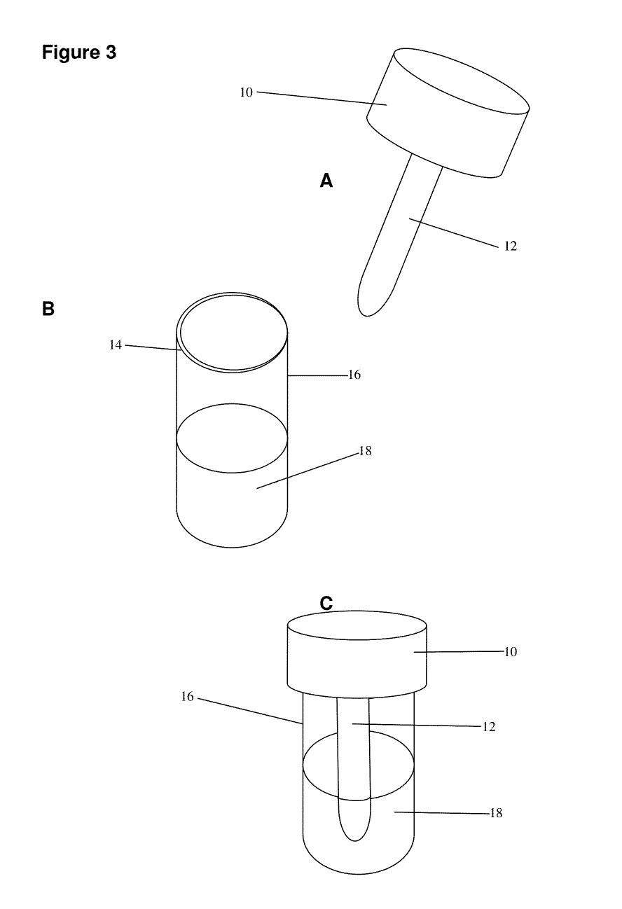

A piece of the nanosilver cotton textile in Example 4 (P2) was cut with a size of 15 cm by 4 cm. As depicted in FIG. 3, the nanosilver cotton textile was subsequently fixed on a round plastic stick (“Stick”) to form a water filter 12. The water filter 12 was soaked in a bottle 16 of rain water 18 (200 ml) for 5 minutes with stirring by hand. The instant counting of the bacterial showed that only 320 colony-forming units were found. As compared, a control test of the un-treated water showed 67000 colony-forming bacterial units. The results indicated that the water filter 12 can remove 99.5% of the bacterial in rain water 18. It was found that the treated water contained 48 ppb silver in the treated water by the measurement of ICP-OES. Hence, the water filter 12 provides the advantage of filtering bacterial contaminants to provide clean water with minimal silver leaching to the environment.

### Example 8

### Nanosilver Acidic-Cellulose Integrated Water Purification Cartridge

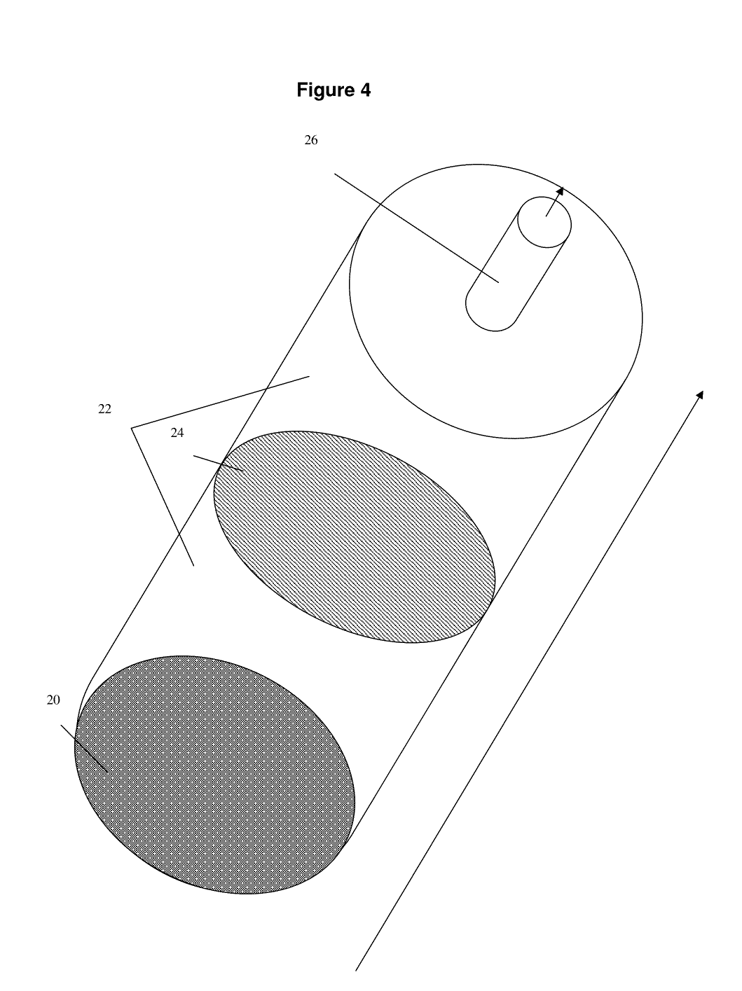

The nanosilver acidic-cellulose (5 g) in Example 3 was mixed with 50 g of active carbon, 3 g of zirconium phosphate and 3 g of hydrous zirconium oxide. Referring to FIG. 4 the mixed substrates were packed into a cartridge 24. The rain water used in Example 7 was pumped through the cartridge 24 with a flow rate of 0.3 ml per minute. The outlet fluent water was collected for instant counting of the bacteria, showing only 58 colony-forming units. The results indicated that the cartridge 24 can remove 99.9% of the bacterial in rain water. This cartridge 24 can be used to filter water for drinking directly in the manner of a filter drinking straw 22 as depicted in FIG. 4. The filter drinking straw 22 of FIG. 4 comprises an inlet 20 that allows water to enter the filter drinking straw 22. Preferably the inlet is a macro-filter 20 such as a sieve that is able to filter large objects such as leaf litter, dirt and the like. It may be made of a wire mesh or any type of hard plastic with small holes or even a second cartridge 24 as described above. Water is sucked manually or pulled with a pump in the direction of the arrow first passing through the macro-filter 20 then through the cartridge 24 and can be directly drank or collected through the outlet 26. This can be done knowing that the water is clean and there is minimal silver leaching so it is safe to drink directly. Such a filter drinking straw 22 will allow anyone to immediately filter water for safe drinking anywhere in the world. It is possible to add additional filters along the filter drinking straw 22 to remove other undesirable attributes such as heavy metals, salt, fertilizers, pesticides or any other compounds that will render the water un-potable by adding other known filters.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

As used in this specification and the appended claims, the singular forms “a”, “an” and “the” include plural reference unless the context clearly dictates otherwise. As used in this specification and the appended claims, the terms “comprise”, “comprising”, “comprises” and other forms of these terms are intended in the non-limiting inclusive sense, that is, to include particular recited elements or components without excluding any other element or component. Unless defined otherwise all technical and scientific terms used herein have the same meaning as commonly understood to one of ordinary skill in the art to which this invention belongs.

All lists or ranges provided herein are intended to include any sub-list or narrower range falling within the recited list or range.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method of immobilizing a metal nanoparticle on a substrate comprising the steps of
a) Modifying the substrate with a linker having a first linker element able to form a covalent bond with an element on the substrate that has a comparable electronegativity with the first linker element; and a second linker element able to chelate a metal ion; and
b) Washing the modified substrate to remove silver ions not chelated to the second linker element prior to reducing the metal ions to form the metal nanoparticles on the substrates with a reducing agent resulting in a treated substrate.

2. The method of claim 1 further comprising the step of isolating the treated substrate stabilized metal nanoparticles.

3. The method of claim 1 further comprising the step of washing the treated substrate with the linker.

4. The method of claim 1 wherein the substrate is a powder, a fiber, a fabric, a sheet or a film comprising at least one of cellulose, cotton, cellophane, rayon, nylon, polyvinyl alcohol, hydroxylated polystyrene, wood, paper, cardboard, linen, polymer element or a mixture thereof.

5. The method of claim 1 wherein the linker is prepared in a single step or in a multiple step process.

6. The method of claim 5 wherein the linker prepared in the single step is selected from the group, (3-mercaptopropyl)trimethoxysilane, bis[3-(triethoxysilyl)propyl]tetrasulfide, (3-aminopropyl)triethoxysilane, (3-aminopropyl)trimethoxysilane, 3-aminopropylmethyldiethoxysilane, N-(2-aminoethyl)-3-aminopropyltrimethoxysilane, N-(2-aminoethyl)-3-aminopropylmethyldimethoxysilane, (3-trimethoxysilylpropyl)diethylene-triamine, n-butylaminopropyltrimethoxysilane, N-ethylaminoisobutyltrimethoxysilane, N-methylaminopropyltrimethoxysilane, N-phyenylaminopropyltrimethoxysilane, bis(triethoxysilylpropyl)amine, bis(trimethoxysilylpropyl)amine, bis[(3-trimethoxysilyl)propyl]ethylenediamine, N-(3-triethoxysilylpropyl)-4,5-dihydroimidazole, ureidopropyltriethoxysilane, 3-isocyanatopropyltriethoxysilane; isocyanate: toluene diisocyanate, and hexamethylene diisocyanate.

7. The method of claim 5 wherein the linker prepared in a multiple step process has a structure of A-Nₙ-B wherein the first linker element (Linker A) is an epoxy group; the first linker element is attached on the substrate, followed by electrophilic addition to a central Linker element N, which can react with the second linker element (Linker B).

8. The method of claim 7 wherein the first linker element, Linker A is selected from the group, 2-(chloromethyl)oxirane, 2-(bromomethyl)oxirane, 2-(iodomethyl)oxirane, 1,4-butanediol diglycidyl ether and a mixture thereof.

9. The method of claim 7 wherein the central linker element, linker N has a formula of Q-R′—P, in which Q represents a functional group which contains a nucleophilic moiety and P represents a functional group which contains an electrophilic moiety. R¹ represents a third linker between Q and P.

10. The method of claim 7 wherein the second linker element, linker B has a formula of Y—R²—Z, in which Y represents a functional group which contains a nucleophilic moiety, Z represents a functional group which contains a functional binding moiety, and R² represents a forth linker between Y and Z.

11. The method of claim 9 wherein the nucleophilic moiety Q comprises at least one of amine, thiol, alcohol, phenol, carboxylate, polymer or a mixture thereof.

12. The method of claim 10 wherein the nucleophilic moiety Y comprises at least one of amine, thiol, alcohol, phenol, carboxylate, polymer or a mixture thereof.

13. The method of claim 9 wherein the electrophilic moiety P comprises a least one of azide, cyanuric, isocyanate, silane or a mixture thereof.

14. The method of claim 10 wherein the binding moiety Z comprises a least one of amine, sulfonic acid, phosphonic acid, carboxylic acid, phosphonate, sulfonate, thiol, carboxylate, azide, cyanuric, isocyanate, alcohols, thiols, polymer or a mixture thereof.

15. The method of claim 9 wherein the functional group R¹ comprises at least one of alkyl, aryl, heteroaryl, vinyl, oligomer, polymer or a mixture thereof.

16. The method of claim 10 wherein the functional group R² comprises at least one of alkyl, aryl, heteroaryl, vinyl, oligomer, polymer or a mixture thereof.

17. The method of claim 1 wherein the metal is selected from the group silver, gold, platinum, palladium, aluminum, iron, zinc, copper, cobalt nickel, manganese, chromium, molybdenum, cadmium, iridium and a mixture thereof.

18. The method of claim 1 wherein the metal is silver.

19. The method of claim 1 wherein the size of metal nanoparticle ranges from 1-2000 nm.

20. The method of claim 1 wherein the reducing agent comprises sodium bromohydrate (NaBH₄), a reducing sugar, N-vinyl pyrrolidinone (NVP), polyvinyl pyrrolidinone (PVP), phenylhydrazine, hydrazine, citrate acid, ascorbic acid, amine, phenol, alcohol or a mixture thereof.

21. The method of claim 2 wherein isolating the treated substrate stabilized metal nanoparticles comprises filtering, washing, drying or a mixture thereof.

22. The method of claim 3 wherein the linker is selected from the group, (3-mercaptopropyl)trimethoxysilane, bis[3-(triethoxysilyl)propyl]tetrasulfide, (3-aminopropyl)triethoxysilane, (3-aminopropyl)trimethoxysilane, 3-aminopropylmethyldiethoxysilane, N-(2-aminoethyl)-3-aminopropyltrimethoxysilane, N-(2-aminoethyl)-3-aminopropylmethyldimethoxysilane, (3-trimethoxysilylpropyl)diethylene-triamine, n-butylaminopropyltrimethoxysilane, N-ethylaminoisobutyltrimethoxysilane, N-methylaminopropyltrimethoxysilane, N-phyenylaminopropyltrimethoxysilane, bis(triethoxysilylpropyl)amine, bis(trimethoxysilylpropyl)amine, bis[(3-trimethoxysilyl)propyl]ethylenediamine, N-(3-triethoxysilylpropyl)-4,5-dihydroimidazole, ureidopropyltriethoxysilane, 3-isocyanatopropyltriethoxysilane; isocyanate: toluene diisocyanate, and hexamethylene diisocyanate.

23. A treated substrate obtained by claim 1 wherein less metal ion is leached to the environment.

24. The treated substrate of claim 23 comprising a colour including red, yellow, blue, green, purple, gray or black

25. The treated substrate of claim 23 comprising antimicrobial properties.

26. The treated substrate of claim 23 for use as a catalyst, water purification devices, absorbent, healthcare products, sensor, food packaging films or a mixture thereof.

27. A device for water purification comprising the treated substrate of claim 23 wherein the metal nanoparticle is silver and the substrate is cotton textile suitable for emersion in water that needs purifying.

28. A cartridge comprising the treated substrate of claim 23 for filtering water.

29. The cartridge of claim 28 further comprising active carbon; and zirconium compounds.

30. The cartridge of claim 28 for use in a filter drinking straw whereby water is able to enter through an inlet, pass through at least one cartridge and be suitable for drinking.
